(19) United States
(12) Patent Application Publication
(10) Pub. No.: US 2009/0174730 A1
(43) Pub. Date: Jul. 9, 2009

(54) DATA DRIVING APPARATUS AND METHOD THEREOF

(75) Inventors: Ming-Wei Huang, Taoyuan County (TW); Kuan-Hung Liu, Taipei County (TW); Te-Feng Tsai, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/204,813

(22) Filed: Sep. 5, 2008

(30) Foreign Application Priority Data
Jan. 9, 2008 (TW) 97100859

(51) Int. Cl. G09G 5/10

(52) U.S. Cl. 345/690

(57) ABSTRACT

A data driving apparatus and a method thereof are disclosed. When the data driving apparatus of the present invention receives a gray level digital value provided by a timing controller (T-con), the data driving apparatus provides a correction/compensation gray level voltage thereby for producing a precise pixel voltage to drive pixels inside an LCD panel of an LCD according to a gamma lookup table and a correction transmissivity lookup table. Therefore, a final color displayed on the LCD can be accorded with the color established by the ideal gamma curve.

### CROSS-REFERENCE TO RELATED APPLICATION

This application claims the priority benefit of Taiwan application serial no. 97100859, filed on Jan. 9, 2008. The entirety of the above-mentioned patent application is hereby incorporated by reference herein and made a part of specification.

### BACKGROUND OF THE INVENTION

1. Field of the Invention

The present invention relates to a data driving apparatus and a method thereof. More particularly, the present invention relates to a data driving apparatus and a method thereof which may solve a color-shift phenomenon of a liquid crystal panel (LCD) driven by a color sequential method.

2. Description of Related Art

With development of optoelectronic and semiconductor techniques, flat panel displays are developed accordingly, in which liquid crystal displays (LCDs) become popular in the market due to features of high space utilization efficiency, low power consumption, no-radiation and low electromagnetic interference etc. It is known that an LCD includes an LCD panel and a backlight module, wherein since the LCD panel has no luminescent function itself, the backlight module is required for providing a backlight source to the LCD panel, so as to achieve a display function of the LCD panel.

In a conventional LCD, a design principle of the backlight module used for providing a planar light source to the LCD panel is to provide a white light, and then the white light is transmitted to color filters on each pixel position within the LCD panel for displaying a color of each pixel. Generally, three color filters, i.e. a red (R) filter, a green (G) filter and a blue (B) filter are required to be disposed on each pixel position to achieve a full color effect. However, such method is not only expensive, but also leads to a low transmissivity of each pixel after the white light being processed by the color filters. Moreover, a color-mixing phenomenon may be occurred at adjacent areas of the three color filters, i.e. the red filter, the green filter and the blue filter.

To solve the problem of color-mixing, in a conventional method, a black matrix can be applied to the adjacent areas of the three color filters for blocking. However, based on such method, the transmissivity of the color filters will be further decreased.

Accordingly, in a lately designed LCD, the backlight source with light-emitting diodes (LEDs) is applied for substituting the conventional white light backlight source, so as to display the colors of the pixels. Namely, the conventional method of mixing colors of the color filters on a spatial axis, i.e. mixing colors of the red, green and blue sub-pixels on the spatial axis within a viewing range of human eyes now may be substituted by mixing colors of the LED backlight module on a time axis. Namely, based on a visual staying principle of the human eyes, images of the three colors red, green and blue are switched swiftly on the time axis, so as to achieve a mixing color effect.

For example, if the images are dynamically displayed for 60 frames per second, and the images of the three colors red, green and blue are switched swiftly on the time axis, a refresh frequency of the images of the three colors red, green and blue is then at least 180 images per second, and this method is the so-called color sequential method. Accordingly, disposing of the color filters on each pixel position of the LCD panel is unnecessary, and the transmissivity of each of the pixels is then improved. However, since the red, green and blue LEDs of the backlight source may have different corresponding transmissivities when a same gray level voltage is exerted, by color mixing based on the visual staying principle of the human eyes, these three colors then may have a color-shift phenomenon.

FIG. 1 is a schematic diagram illustrating transmissivities respectively corresponding to red, green and blue LEDs of a backlight source when a gray level voltage is exerted. Wherein, a horizontal axis represents the gray level voltage (V), and a vertical axis represents the transmissivities (%). Referring to FIG. 1, the dotted lines ( - - - ) represents a same linear feature curve representing a relation between the exerted gray level voltage (V) and the corresponding transmissivities (%) respectively presented by the three colors LEDs of the light source in an ideal state. However, in an actual state, when a same gray level voltage Va is exerted to the backlight source with three colors (red, green and blue) LEDs, the red LED backlight source provides a red color brighter than that to be presented, and the green and the blue LED backlight sources provide a green color and a blue color darker than that to be presented. Therefore, by color mixing based on the visual staying principle of the human eyes, the color-shift phenomenon is occurred, namely, the observed color is red-shifted after the color mixing.

### SUMMARY OF THE INVENTION

Accordingly, the present invention is directed to a data driving apparatus and a method thereof, in which a gamma lookup table and a correction transmissivity lookup table are applied for solving a color-shift phenomenon of a liquid crystal display (LCD) caused by applying of a conventional color sequential driving method.

Based on aforementioned and other objectives, the present invention provides a data driving apparatus including a gamma lookup unit, a calculation processing unit, and a driving unit. The gamma lookup unit has a gamma lookup table with a built-in establishment gamma curve (for example, the establishment gamma curve with a gamma value of 2.2) and an ideal gamma curve. The gamma lookup unit is used for receiving a gray level digital value, and finding a corresponding establishment transmissivity and an ideal transmissivity from the establishment gamma curve and the ideal gamma curve.

The calculation processing unit is coupled to the gamma lookup unit and has a correction transmissivity lookup table, and is used for finding whether or not there is a first correction transmissivity being identical to the ideal transmissivity from a built-in correction transmissivity curve of the correction transmissivity lookup table. If yes, a first correction gray level voltage corresponding to the first correction transmissivity is then output. The driving unit is coupled to the calculation processing unit, and is used for receiving the first correction gray level voltage, so as to generate a pixel voltage for driving a pixel within the LCD panel.

In an embodiment of the present invention, if the calculation processing unit cannot find the first correction transmissivity being identical to the ideal transmissivity, a second correction gray level voltage corresponding to a second correction transmissivity which is the closest to and less than the ideal transmissivity is then found. Next, according to a establishment gray level voltage corresponding to the establishment transmissivity, the second correction gray level voltage and the establishment gray level voltage are operated based on an interpolation algorithm to obtain a compensation gray level voltage, wherein a compensation transmissivity corresponding to the compensation gray level voltage is the establishment transmissivity. By such means, the driving unit then may generate the pixel voltage according to the compensation gray level voltage for driving a pixel within the LCD panel.

According to another aspect, the present invention provides a data driving method including the following steps. First, a gamma lookup table with a built-in establishment gamma curve (for example, the establishment gamma curve with a gamma value of 2.2) and an ideal gamma curve is provided. Second, a correction transmissivity lookup table with a built-in correction transmissivity curve is provided. Third, a corresponding establishment transmissivity and an ideal transmissivity are found from the establishment gamma curve and the ideal gamma curve according to a gray level digital value. Fourth, whether or not there is a first correction transmissivity being identical to the ideal transmissivity is judged, and if yes, a first correction gray level voltage corresponding to the first correction transmissivity is then generated. Finally, a pixel voltage is generated according to the first correction gray level voltage for driving a pixel within the LCD panel.

In an embodiment of the present invention, if the first correction transmissivity being identical to the ideal transmissivity cannot be found, the following steps are performed. First, a second correction gray level voltage corresponding to a second correction transmissivity which is the closest to and less than the ideal transmissivity is then found. Next, according to a establishment gray level voltage corresponding to the establishment transmissivity, the second correction gray level voltage and the establishment gray level voltage are operated based on an interpolation algorithm to obtain a compensation gray level voltage, wherein a compensation transmissivity corresponding to the compensation gray level voltage is the establishment transmissivity. Finally, the pixel voltage is then generated according to the compensation gray level voltage for driving the pixel.

In the aforementioned embodiment, the correction transmissivity curve records the first and the second correction gray level voltages respectively corresponding to the first and the second correction transmissivities. Moreover, the LCD panel may be an optical compensation bend (OCB) LCD panel.

In the aforementioned embodiment, the establishment gamma curve includes a red establishment gamma curve, a green establishment gamma curve or a blue establishment gamma curve.

According to the data driving apparatus and the method thereof provided by the present invention, since the gamma lookup table is preformed by the establishment gamma curve with the gamma value thereof being 2.2 and the ideal gamma curve, and the correction transmissivity lookup table is preformed by the correction transmissivity curve, when the gray level digital value is received, the gamma lookup unit may individually find the corresponding establishment transmissivity and the ideal transmissivity according to the gamma lookup table therein.

Next, the calculation processing unit may find a correction/compensation transmissivity being identical to the ideal transmissivity according to the correction transmissivity lookup table therein, and provide a correction/compensation gray level voltage corresponding to the correction/compensation transmissivity for the driving unit. Finally, the driving unit generates the pixel voltage to drive the pixel inside the LCD panel. Therefore, according to the data driving apparatus and the method thereof provided by the present invention, a final color displayed on the LCD can be accorded with the color established by the ideal gamma curve, such that the color-shift problem of an LCD caused by applying of a conventional color sequential method may be solved.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram illustrating transmissivities respectively corresponding to red, green and blue LEDs of a backlight source when a gray level voltage is exerted.

FIG. 2 is a block diagram illustrating an LCD according to an embodiment of the present invention.

FIG. 3 is a block diagram illustrating a data driving apparatus of FIG. 2.

FIG. 4 is a schematic diagram illustrating a built-in red establishment gamma curve and an ideal gamma curve of the gamma lookup table of FIG. 3.

FIG. 5 is a schematic diagram illustrating a built-in correction transmissivity curve of the correction transmissivity lookup table of FIG. 3.

FIG. 6 is a flowchart illustrating a data driving method according to an embodiment of the present invention.

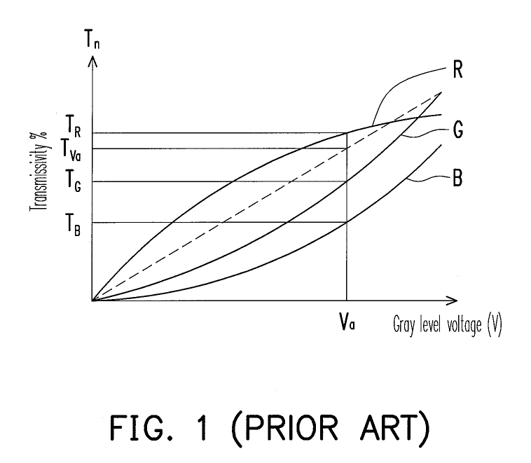

### DESCRIPTION OF EMBODIMENTS

A technique effect to be achieved by the present invention is to solve a color-shift phenomenon of a liquid crystal display (LCD) applying a conventional color sequential method. The technique features of the present invention and technique effects to be achieved by the present invention will be described in detail below for those skilled in the art.

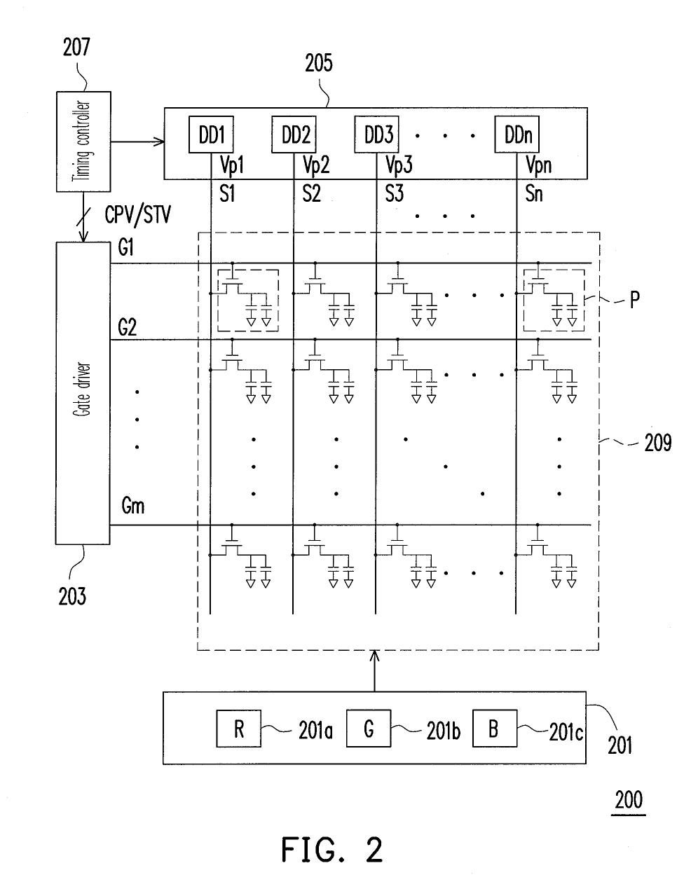

FIG. 2 is a block diagram illustrating an LCD 200 according to an embodiment of the present invention. Referring to FIG. 2, the LCD 200 includes a backlight module 201, a gate driver 203, a source driver 205, a timing controller 207 and an LCD panel 209. The backlight module 201 is composed of a plurality of red, green and blue light-emitting diodes (LEDs) 201a, 201b and 201c for timingly providing a red light source, a green light source and a blue light source to function as the backlight source of the LCD panel 209. Namely, the LCD 200 applies a color sequential driving method. Moreover, the LCD panel 209 may be an optical compensation bend (OCB) LCD panel.

The gate driver 203 includes a plurality of gate lines G1˜Gm for sequentially outputting scan signals after receiving a basic timing CPV and a start pulse STV provided by the timing controller 207, so as to correspondingly activate pixels of each row within the LCD panel 209. The source driver 205 includes a plurality of source lines S1˜Sn and a plurality of data driving apparatus DD1˜DDn, wherein each of the data driving apparatus DD1˜DDn is used for correspondingly receiving a gray level digital value DR/DG/DB provided by the timing controller 207, so as to generate a pixel voltage Vp1˜Vpn for the corresponding source line S1˜Sn to drive the pixel P within the LCD panel 209.

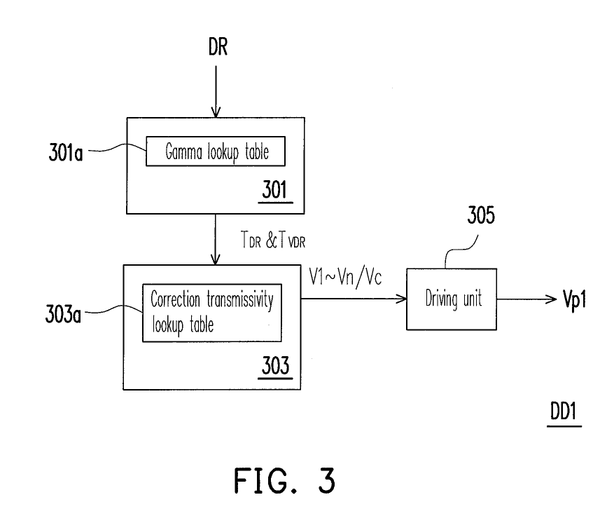

In the following content, the data driving apparatus DD1 is taken as an example, and the backlight module 201 is assumed to provide a red light source presently. FIG. 3 is a block diagram illustrating a data driving apparatus DD1 of the present embodiment. Referring to FIG. 2 and FIG. 3, the data driving apparatus DD1 includes a gamma lookup unit 301, a calculation processing unit 303 and a driving unit 305. The gamma lookup unit 301 has a gamma lookup table 301a with a built-in establishment gamma curve (for example, a red establishment gamma curve with a gamma value of 2.2, though the present invention is not limited thereto) and an ideal gamma curve.

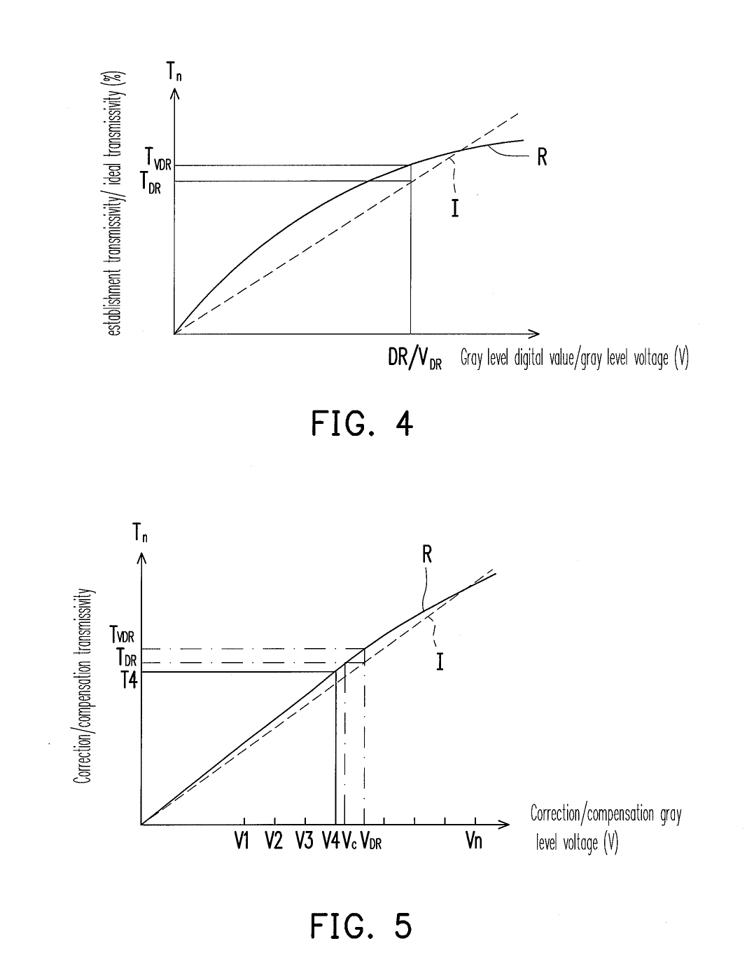

In the present embodiment, the gamma lookup unit 301 is used for receiving the gray level digital value DR provided by the timing controller 207, and individually finding a establishment transmissivity and an ideal transmissivity from the built-in red establishment gamma curve and the ideal gamma curve of the gamma lookup table 301a. For example, FIG. 4 is a schematic diagram illustrating a built-in red establishment gamma curve R and an ideal gamma curve I of the gamma lookup unit 301 according to the present embodiment. Referring to FIG. 3 and FIG. 4, the gray level digital value DR provided by the timing controller 207 represents a gray level voltage V_{DR}, and the gray level voltage V_{DR} may individually correspond to a establishment transmissivity T_{VDR} and an ideal transmissivity T_{DR} respectively on the red establishment gamma curve R and the ideal gamma curve I.

The calculation processing unit 303 includes a correction transmissivity lookup table 303a with a built-in correction transmissivity curve. FIG. 5 is a schematic diagram illustrating a built-in correction transmissivity curve of the correction transmissivity lookup table 303a according to the present embodiment. Referring to FIGS. 3 to FIG. 5, in FIG. 5, it is obvious that the built-in correction tramnissivity curve of the correction transmissivity lookup table 303a records a plurality of correction gray level voltages V₁˜Vₙ corresponding to a plurality of correction transmissivities T₁˜Tₙ.

Therefore, while taking the red establishment gamma curve R as a reference, the calculation processing unit 303 then finds whether or not there is the first correction transmissivity T₁/T₂/ . . . /Tₙ being identical to the ideal transmissivity T_{DR} within the built-in correction transmissivity lookup table 303a thereof according to the establishment transmissivity T_{VDR} and the ideal transmissivity T_{DR} found by the gamma lookup unit 301 based on the gray level digital value DR provided by the time controller 207. If yes, the first correction gray level voltage V₁/V₂/ . . . /Vₙ corresponding to the first correction transmissivity T₁/T₂/. . . /Tₙ being identical to the ideal transmissivity T_{DR} is then output to the driving unit 305. Consequently, the driving unit 305 then generates the pixel voltage VP1 according to the output first correction gray level voltage V₁/V₂/ . . . /Vₙ for driving the pixel P within the LCD panel 209 of the LCD 200.

However, according to FIG. 5, it is obvious that the ideal transmissivity T_{DR} corresponding to the gray level voltage V_{DR} representing the gray level digital value DR provided by the timing controller 207 does not correspond to any of the first correction transmissivity T₁/T₂/ . . . /Tₙ, and therefore the calculation processing unit 303 may find a second correction gray level voltage V₄ corresponding to a second correction transmissivity T₄ which is the closest to and less than the ideal transmissivity TDR, while taking the red establishment gamma curve R as the reference. Moreover, with reference of the establishment gray level voltage (i.e. the gray level voltage V_{DR}) corresponding to the establishment transmissivity T_{VDR}, the second correction gray level voltage V₄ and the establishment gray level voltage are operated based on an interpolation algorithm to obtain a compensation gray level voltage V_{C}, such that the driving unit then may generate the pixel voltage Vp1 according to the compensation gray level voltage V_{C} for driving the pixel P within the LCD panel 209 of the LCD 200.

In the present embodiment, a compensation transmissivity corresponding to the compensation gray level voltage V_{C} is the ideal transmissivity T_{DR}, and the interpolation algorithm is as follows:

(T_{VDR}−T₄)/(V_{DR}−V₄)=(T_{DR}−T₄)/(V_{C}−V₄)

According to the spirit of the present invention, obtaining of the compensation gray level voltage V_{C} is not limited to the interpolation algorithm. Namely, an extrapolation algorithm or other operation method may also be applied according to an actual requirement, so as to obtain the compensation gray level voltage V_{C}.

Accordingly, after the data driving apparatus DD1 of the present embodiment receives the gray level digital value DR provided by the timing controller 207, the data driving apparatus DD1 provides a correction/compensation gray level voltage V₁˜Vₙ/V_{C} according to the gamma lookup table 301a and the correction transmissivity lookup table 303a for the driving unit 305 to generate the precise pixel voltage Vp1, so as to drive the pixel P within the LCD panel 209 of the LCD 200. Therefore, a red color finally displayed on the LCD 200 can be accorded with the color established by the ideal gamma curve I.

Moreover, those skilled in the art may easily deduce an activation method of the data driving apparatus DD1 when the backlight module 201 provides the green light source or the blue light source. Namely, the built-in red establishment gamma curve R of the gamma lookup unit 301 may be substituted by a green establishment gamma curve G or a blue establishment gamma curve B, and detailed description thereof will not be repeated. Therefore, a red/green/blue color finally displayed on the LCD 200 can be accorded with the color established by the ideal gamma curve I, such that the color-shift problem may be avoided after color mixing based on a visual staying principle of the human eyes.

To further convey the spirit of the data driving apparatus DD1˜DDn of the aforementioned embodiment, another data driving method is further provided for those skilled in the art.

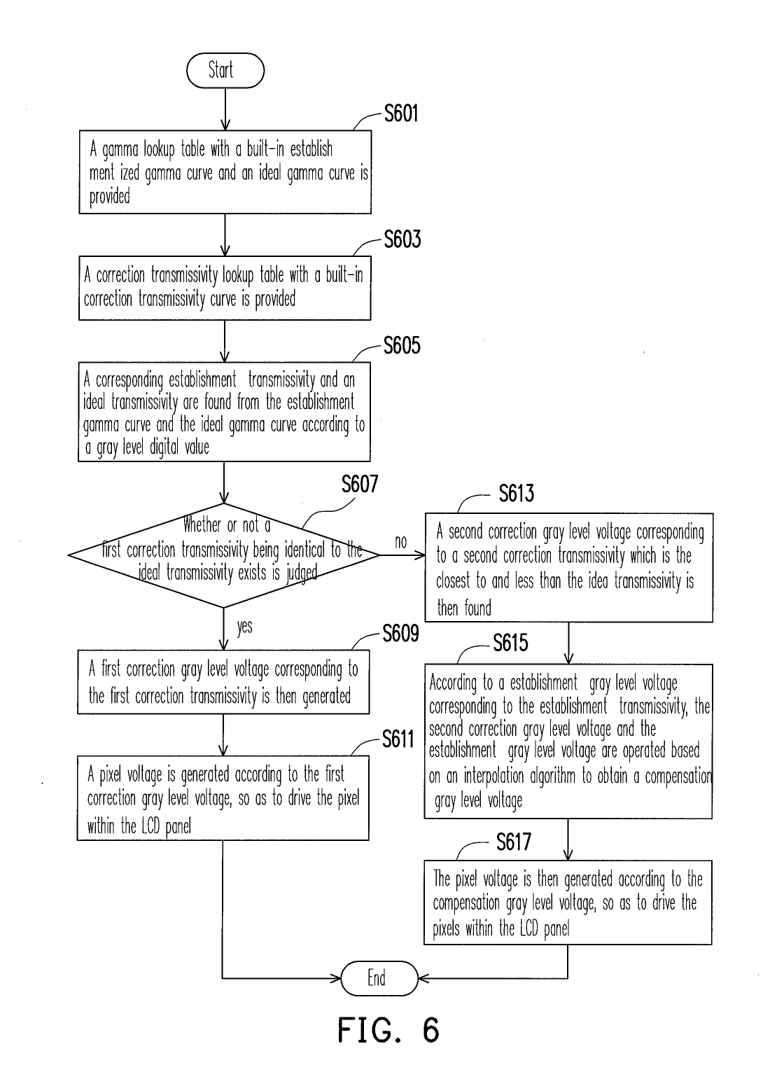

FIG. 6 is a flowchart illustrating a data driving method according to an embodiment of the present invention. Referring to FIG. 6, the data driving method of the present embodiment is suitable for an LCD having a backlight module for timingly providing a red light source, a green light source and a blue light source to function as the backlight source of the LCD panel. Namely, the LCD of the present embodiment applies the color sequential driving method. Moreover, the LCD panel thereof may be an OCB LCD panel.

The data driving method of the present embodiment is as follows. First, in step S601, a gamma lookup table with a built-in establishment gamma curve (for example, a red, green or a blue establishment gamma curve with a gamma value of 2.2) and an ideal gamma curve is provided. Next, in step S603, a correction transmissivity lookup table with a built-in correction transmissivity curve is provided. In the present embodiment, the correction transmissivity curve records a plurality of correction gray level voltages respectively corresponding to a plurality of correction transmissivities.

Next, in step S605, a corresponding establishment transmissivity and an ideal transmissivity are found from the establishment gamma curve and the ideal gamma curve respectively mentioned in the step S601 and the step S603 according to a gray level digital value, wherein the gray level digital value is provided by the timing controller of the LCD. Next, in step S607, whether or not there is a first correction transmissivity being identical to the ideal transmissivity is judged. If yes, in step S609, a first correction gray level voltage corresponding to the first correction transmissivity is then generated. Finally, in step S611, a pixel voltage is generated according to the first correction gray level voltage generated according to the step S609, so as to drive the pixel within the LCD panel.

Moreover, in the step S607, if the first correction transmissivity being identical to the ideal transmissivity cannot be found, in step S613, a second correction gray level voltage corresponding to a second correction transmissivity which is the closest to and less than the ideal transmissivity is then found. Next, in step S615, according to a establishment gray level voltage corresponding to the establishment transmissivity, the second correction gray level voltage and the establishment gray level voltage are operated based on an interpolation algorithm to obtain a compensation gray level voltage, wherein a compensation transmissivity corresponding to the compensation gray level voltage is the ideal transmissivity. Finally, in step S617, the pixel voltage is then generated according to the compensation gray level voltage generated based on the step S617, so as to drive the pixel within the LCD panel.

Accordingly, a red/green/blue color finally displayed on the LCD 200 can be accorded with the color established by the ideal gamma curve mentioned in the step S601, such that the color-shift problem of an LCD caused by applying of a conventional color sequential method may be solved.

In addition, according to the spirit of the present invention, the present invention is not limited to the aforementioned embodiment. Namely, according to the data driving apparatus and the method thereof provided by the present invention, in another embodiment, by embedding the gamma lookup unit 301 and the calculation processing unit 303 of the data driving apparatus DD1˜DDn within the timing controller 207, the gray level digital value DR/DG/DB provided to a general source driver then may be directly corrected, and accordingly the spirit of the present invention may also be achieved.

In summary, according to the data driving apparatus and the method thereof provided by the present invention, since the gamma lookup table is preformed by the establishment gamma curve with the gamma value thereof being 2.2 and the ideal gamma curve, and the correction transmissivity lookup table is preformed by the correction transmissivity curve recording the plurality of correction gray level voltages respectively corresponding to the plurality of correction transmissivities, when the gray level digital value is received, the gamma lookup unit may individually find the corresponding establishment transmissivity and the ideal transmissivity according to the gamma lookup table therein.

Next, the calculation processing unit may find a correction/compensation transmissivity being identical to the ideal transmissivity according to the correction transmissivity lookup table therein, and provide a correction/compensation gray level voltage corresponding to the correction/compensation transmissivity for the driving unit. Finally, the driving unit generates the pixel voltage to drive the pixel inside the LCD panel. Therefore, according to the data driving apparatus and the method thereof provided by the present invention, a final color displayed on the LCD can be accorded with the color established by the ideal gamma curve, such that the color-shift problem of an LCD caused by applying of a conventional color sequential method may be solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data driving apparatus, comprising:
a gamma lookup unit, having a gamma lookup table, wherein the gamma lookup table has a built-in establishment gamma curve and an ideal gamma curve, the gamma lookup unit is used for receiving a gray level digital value for individually finding a corresponding establishment transmissivity and an ideal transmissivity from the establishment gamma curve and the ideal gamma curve;
a calculation processing unit, coupled to the gamma lookup unit, and having a correction transmissivity lookup table, wherein the calculation processing unit is used for finding whether or not there is a first correction transmissivity being identical to the ideal transmissivity from the correction transmissivity lookup table, and if yes, a first correction gray level voltage corresponding to the first correction transmissivity is then output; and
a driving unit, coupled to the calculation processing unit, for receiving the first correction gray level voltage, so as to generate a pixel voltage for driving a pixel within a liquid crystal display (LCD) panel.

2. The data driving apparatus as claimed in claim 1, wherein if the calculation processing unit cannot find the first correction transmissivity being identical to the ideal transmissivity, a second correction gray level voltage corresponding to a second correction transmissivity which is the closest to and less than the ideal transmissivity is then found, and according to a establishment gray level voltage corresponding to the establishment transmissivity, the second correction gray level voltage and the establishment gray level voltage are operated based on an interpolation algorithm to obtain a compensation gray level voltage,
wherein a compensation transmissivity corresponding to the compensation gray level voltage is the ideal transmissivity.

3. The data driving apparatus as claimed in claim 2, wherein the driving unit further generates the pixel voltage according to the compensation gray level voltage for driving the pixel.

4. The data driving apparatus as claimed in claim 2, wherein the correction transmissivity lookup table has a built-in correction transmissivity curve, and the correction transmissivity curve records the first and the second correction gray level voltages respectively corresponding to the first and the second correction transmissivities.

5. The data driving apparatus as claimed in claim 1, wherein the establishment gamma curve comprises a red establishment gamma curve, a green establishment gamma curve or a blue establishment gamma curve.

6. The data driving apparatus as claimed in claim 1, wherein the LCD panel is an optical compensation bend (OCB) LCD panel.

7. A data driving method, comprising:
providing a gamma lookup table with a built-in establishment gamma curve and an ideal gamma curve;
providing a correction transmissivity lookup table with a built-in correction transmissivity curve;
respectively finding a corresponding establishment transmissivity and an ideal transmissivity from the establishment gamma curve and the ideal gamma curve according to a gray level digital value;
finding whether or not there is a first correction transmissivity being identical to the ideal transmissivity from the correction transmissivity lookup table, wherein if yes, a first correction gray level voltage corresponding to the first correction transmissivity is generated; and
generating a pixel voltage according to the first correction gray level voltage for driving a pixel within an LCD panel,
wherein, the correction transmissivity curve records the first correction gray level voltage corresponding to the first correction transmissivity.

8. The data driving method as claimed in claim 7, wherein if the first correction transmissivity being identical to the ideal transmissivity is not found, the following steps are executed:
finding a second correction gray level voltage corresponding to a second correction transmissivity which is the closest to and less than the ideal transmissivity; and
performing an interpolation algorithm to the second correction gray level voltage and a establishment gray level voltage according to the establishment gray level voltage corresponding to the establishment transmissivity, so as to obtain a compensation gray level voltage,
wherein a compensation transmissivity corresponding to the compensation gray level voltage is the ideal transmissivity.

9. The data driving method as claimed in claim 8, further comprising:
generating the pixel voltage according to the compensation gray level voltage for driving the pixel.

10. The data driving method as claimed in claim 8, wherein the correction transmissivity curve further records the second correction gray level voltage corresponding to the second correction transmissivity.

11. The data driving method as claimed in claim 7, wherein the establishment gamma curve comprises a red establishment gamma curve, a green establishment gamma curve or a blue establishment gamma curve.

12. The data driving method as claimed in claim 7, wherein the LCD panel is an optical compensation bend (OCB) LCD panel.
